(19) United States
(12) Patent Application Publication
(10) Pub. No.: US 2022/0140417 A1
(43) Pub. Date: May 5, 2022

(54) Battery Device Resistant to Thermal Runaway and Motor Vehicle

(71) Applicant: Bayerische Motoren Werke Aktiengesellschaft, Muenchen (DE)

(72) Inventors: Franz FUCHS, Muenchen (DE); Kevin GALLAGHER, Naperville, IL (US); Martin HILLER, Muenchen (DE); Christophe MILLE, Villard de Lans (FR); Frederik MORGENSTERN, Muenchen (DE); Nikolaos TSIOUVARAS, Muenchen (DE); Seokyoon YOO, Baldham (DE)

(21) Appl. No.: 17/451,903

(22) Filed: Oct. 22, 2021

(30) Foreign Application Priority Data
Oct. 30, 2020 (DE) 10 2020 128 576.0

(51) Int. Cl. H01M 10/6554; H01M 10/613; H01M 10/625; H01M 10/653

(52) U.S. Cl. CPC H01M 10/6554; H01M 10/613; H01M 2220/20; H01M 10/653; H01M 10/625

(57) ABSTRACT

A battery device includes a plurality of battery cells with individual cell cases. For each of the battery cells, an individual layer arrangement including a cell-side carrier layer and an outside reflecting layer abuts against a side of the cell case facing at least one other of the battery cells.

### CROSS REFERENCE TO RELATED APPLICATION

This application claims priority under 35 U.S.C. § 119 from German Patent Application No. 10 2020 128 576.0, filed Oct. 30, 2020, the entire disclosure of which is herein expressly incorporated by reference.

### BACKGROUND AND SUMMARY OF THE INVENTION

The present invention relates to a battery device, in particular for a motor vehicle, and a motor vehicle having at least one such battery device.

Batteries, in particular rechargeable batteries based on lithium ion technology, are now being increasingly used and are widespread in many technical areas. Thus, the safety of these batteries is of particular importance. It is known, for example, that damaged or defective battery cells of a lithium-ion battery can react exothermically, i.e. can undergo thermal runaway. In this case, energy released in a respective environment can also excite neighbouring battery cells to an exothermic reaction or destruction so that it can result in a chain reaction (thermal propagation) which can not only destroy the entire battery but can also pose a considerable hazard potential for persons and devices in a respective environment.

As one approach to counter this problem, WO 2014/134 589 A1 describes a rechargeable battery with battery cell separators. The battery in this case comprises a plurality of individual battery cells as well as dielectric separators. These dielectric separators form thermal barriers between mutually opposite surfaces of the battery cells. To this end, the dielectric separators are fabricated from a fibre composite material. The electrical separators should provide a thermal and electrical insulation of the battery cells, with the result that a thermal chain reaction inside the battery should be avoided.

A battery module which should provide an improved safety is also described in KR 10 2013 0 141 769 A. In this case, a heat-blocking element is arranged between a battery cell and an outer case in which an endothermic inorganic material is enclosed. If a foreign body penetrating from outside damages a battery cell, the endothermic material can absorb the heat thereby generated in an endothermic reaction, for example, evaporation of water. As a result, a direct effect of heat on neighbouring battery cells should be reduced and thus a thermal chain reaction should be avoided.

It is the object of the present invention to enable a particularly safe use of a multi-cell battery.

This object is solved according to the claimed invention.

A battery device according to an embodiment of the invention comprises a plurality of battery cells with individual cell cases. The battery device can, for example, be a cell composite, a battery module or a complete battery with a plurality of battery cells or a plurality of battery modules. The battery device can additionally comprise a module or outer case in which a plurality of or all the battery cells can be accommodated. The battery cells in the present sense can be rechargeable cells, in particular based on a lithium or lithium ion technology. The plurality of battery cells can be electrically connected to one another in series, in parallel and/or in a combination thereof so that the battery device can overall have a greater nominal or operating voltage than each individual one of the individual battery cells taken by itself.

The cell cases of the individual battery cells are each covered with an individual layer arrangement for each of the battery cells at least on their sides facing at least one other of the battery cells. The layer arrangement in this case comprises a cell-side carrier layer and an outside reflecting layer. For an individual battery cell, the reflecting layer is in other words therefore arranged on a side of the carrier layer facing away from the cell case of this battery cell whereas the carrier layer can abut indirectly or directly against the cell case. A direct abutting means in this case that no other material or component is located between the respective elements or components, here therefore between the cell case and the heat-insulating layer. An indirect abutment can mean in the present sense that another element or material is arranged between the respective elements or components. This can be the case here for example when the carrier layer is held on the cell case by way of an adhesive or a compensating compound. The carrier layer can preferably have heat-insulating properties, i.e. can be formed from a heat-insulating material, at least compared to a metal cell case. For example, the carrier layer can be formed from a plastic material or an aerogel or the like. Thus, the carrier layer can be designated or can be designated hereinafter as heat-insulating layer without restricting the generality.

The layer arrangements can be interpreted as parts of the individual battery cells or as separate components.

In an exothermic reaction or a thermal runaway of one of the battery cells, heat is emitted from this battery cell into its surroundings. This heat can be transported in this case through the layer arrangement of this battery cell, wherein the layer arrangement thereof is broken through or at least partially destroyed since temperatures of several hundred degrees Celsius can occur here. In each case, during the thermal runaway of the battery cell heat or energy for example transported through material escaping from the battery cell undergoing thermal runaway and/or in the form of thermal radiation, can enter into or be introduced into the surroundings of this battery cell. This heat or energy can then act upon at least one neighbouring cell, i.e. at least one of the plurality of battery cells arranged in the surroundings of the battery cell undergoing thermal runaway. The layer arrangement of this neighbouring cell can in this case effectively avoid or at least delay any thermal runaway of this neighbouring cell, with the result that overall a safety gain is achieved for the entire battery device or its use and surroundings.

The carrier layer of the layer arrangement of the neighbouring cell functions as a thermal barrier which can reduce or at least slow down any heat input into the neighbouring cell based on convection and/or heat conduction. The reflecting layer of the layer arrangement of the neighbouring cell can on the other hand reflect thermal radiation incident from the surroundings of the neighbouring cell, i.e. inhibit a radiative heat input from the surroundings into the neighbouring cell. As a result, a portion of the heat or energy produced by the battery cell undergoing thermal runaway and reaching the neighbouring cell can be transported away from the neighbouring cell without contributing significantly to its heating. As a result, the risk that the neighbouring cell will also be excited to thermal runaway can be significantly reduced. The reflecting layer can therefore reflect thermal radiation emanating from the battery cell undergoing thermal runaway into the surroundings of the neighbouring cell and thus distribute corresponding energy over a larger volume, which can advantageously result in a more uniform temperature increase inside the battery device during thermal runaway of a battery cell and thus can avoid local temperature peaks or so-called hotspots.

The battery device according to an embodiment of the invention can, for example, be used for vehicles, possibly as a traction battery of a motor vehicle but also for other applications.

In a further possible embodiment of the present invention, the individual cell cases of the battery cells each have an upper side and a lower side opposite this as well as a completely circumferential lateral surface connecting the upper side and the lower side together. In a cylindrical cell this lateral surface can, for example, correspond to the cylinder jacket, i.e. a single surface. In the case of a prismatic battery cell, the lateral surface can be composed of a plurality of, for example side or partial surfaces at an angle which differs from 0° and 180° with respect to one another.

The fact that the lateral surface runs around completely can mean here that the lateral surface surrounds an interior of the respective battery cell in a dimension or plane, namely in the circumferential direction about an imaginary axis running from the lower side to the upper side through a centre point of the respective battery cell.

The lateral surfaces are in this case at least substantially completely covered by the respective layer arrangement. The battery cells or cell cases thereof are therefore at least substantially completely encased by the layer arrangement at least in the said one dimension or plane, i.e. on the lateral or side surfaces thereof. As a result, the layer arrangement can act particularly effectively and reliably as a barrier for a heat input from the surroundings of the respective battery cell. For example, heat which reaches the respective neighbouring cell from the battery cell undergoing thermal runaway not on the straight or direct path but along other or secondary heat transport paths for example on a side facing away from the battery cell undergoing thermal runaway, can thus be reflected by the reflecting layer or prevented by the carrier layer from directly entering into the interior of the neighbouring cell. Overall the safety of the battery device can thus be further improved.

In a further possible embodiment of the present invention, the carrier layer is formed from an electrically insulating material. This can, for example, be a plastic or polymer material such as polyethylene (PE), polypropylene (PP), polyethylene terephthalate (PET) or the like. This can also contribute to further improved safety of the battery device since as a result of the electrically insulating effect of the carrier layer, electrical flashovers or short circuits between the battery cells can be avoided or inhibited. In addition, the electrically insulating, i.e. non-conducting configuration of the carrier layer allows the reflecting layer to be fabricated from an electrically conductive material, for example, a metallic material without this resulting in any impairment of the electrical properties or mode of operation of the battery cells. Such electrically conductive or metallic materials or substances can have a particularly high reflectivity so that the safety of the battery device can be further improved.

In a further possible embodiment of the present invention, the carrier layer is configured to be liquid-tight. For this purpose, the carrier layer can, for example, be formed from a liquid-tight, in particular liquid-resistant and/or corrosion-resistant material. In addition, the carrier layer can be configured as an uninterrupted surface element, i.e. without holes or recesses through which liquid could penetrate. These properties can be achieved, for example, by a plastic or polymer material. As a result of the liquid-tight configuration of the carrier layer proposed here, it can optionally be prevented that liquid emanating from the battery cell undergoing thermal runaway, for example a liquid electrolyte or the like, damages the neighbouring cells or electrically contacts the cell case thereof. Furthermore, due to the liquid-tight configuration of the carrier layer, the individual battery cells can be additionally protected against moisture from outside such as against air moisture or, for example, in the event of a leakage of a battery cooler, against cooling liquid. Such liquid or moisture reaching or entering the battery cells from outside could otherwise likewise result in problems since they act, for example, in a corrosion-promoting manner and/or can lead or contribute to the formation of a flammable gas mixture via electrolysis of water with the formation of hydrogen. Thus, as a result of the liquid-tight configuration of the carrier layer, ultimately a further contribution can be made to the improved safety of the battery device.

In a further possible embodiment of the present invention, the carrier layer is formed from a polymer film. In other words, the carrier layer is therefore a polymer film or comprises at least one such film. As a result of using a polymer film, on the one hand the favourable properties mentioned elsewhere such as the electrical insulation effect and the liquid tightness can be achieved. On the other hand, polymer films can be sufficiently flexible in order to cover cell cases having almost any shape in a close-fitting manner and additionally require only particularly small installation space. This is desirable in order to allow the highest possible energy density of the battery device such as is increasingly required today for many usage purposes. Overall as a result of the configuration of the carrier layer as a polymer film, the said advantages can therefore optionally be implemented or achieved better or to greater extents or more simply than, for example, due to rigid plate-shaped separators between the battery cells.

In a possible further development of the present invention, the polymer film is formed, i.e. fabricated, from a polyimide. Depending on the case of application or requirements, different polyimides can optionally be used. Polyimides can, for example, compared to other plastic materials, favourably be non-fusible, chemically resistant and particularly heat- and radiation-resistant, have a particularly low outgassing and be electrically insulating. Polyimides can have a particularly high electrical dielectric strength of, for example, several 100 kV/mm. Thus, according to a finding forming the basis of embodiments of the present invention, polyimides are particularly suitable materials for the carrier layer through which the said advantageous properties can therefore be achieved or implemented particularly comprehensively and effectively.

In a further possible embodiment of the present invention, the reflecting layer is configured as a metal coating of the carrier layer. The reflecting layer can for this purpose be vapour-deposited, sputtered, laminated or printed onto the carrier layer. Thus, the carrier layer and the reflecting layer or the entire layer arrangement of at least one battery cell can be handled as a single component which can enable a particularly simple and reliable fabrication of the battery device. Since the reflecting layer is fabricated only as a coating and not as a separate, independent or intrinsically stable component, the reflecting layer can be particularly thin. As a result, weight, installation space and costs can again be saved, for example, compared to a fabrication of the reflecting layer as a separate independent component. The reflecting layer is fabricated here from a metallic material, for example, aluminium or gold or the like, which enables a particularly high reflectivity so that the heating of the respective battery cell in the case of a thermal defect of another battery cell in the surroundings can be reduced or slowed down particularly effectively. Effects of possibly undesired properties of metallic materials such as, for example, their relatively high density, thermal conductivity and/or heat capacity can be reduced in this case by a particularly small thickness or material thickness of the reflecting layer which is made possible by its formation as a coating.

In a further embodiment of the present invention, the reflecting layer has a smaller layer thickness than that of the carrier layer. The reflecting layer is in other words therefore thinner than the carrier layer in a transverse direction which is locally perpendicular on a principal extension surface of the layer arrangement. As a result of the correspondingly thin configuration of the reflecting layer, its reflection effect is not significantly reduced whereas at the same time installation space, costs and weight can be saved or saved installation space can be used for a correspondingly thicker configuration of the carrier layer. This makes it possible to achieve an effect or effectiveness of the carrier layer which is dependent on the thickness of the carrier layer and therefore accordingly greater than a thermal barrier. Due to the smaller layer thickness of the reflecting layer this can easily be fabricated from a metallic material as explained elsewhere in order to achieve a particularly high reflectivity.

In a further possible embodiment of the present invention, the battery device has a cooling plate on which the battery cells are arranged. For example, the battery cells can stand with their respective lower side on the cooling plate. The layer arrangements, in particular the reflecting layers, extend as far as the cooling plate in this case. The layer arrangements or the reflecting layers can therefore be in direct heat-conducting contact with the cooling plate at a respective base or base region of the battery cells facing the cooling plate. By this approach, an additional heat dissipation path is created for the heat or energy incident from the respective surroundings on the battery cell or the layer arrangement. Thus, the heating of the respective battery cell by heat or energy incident or acting from outside can be even further reduced. This can be particularly effective combined with an embodiment of the reflecting layer made of a metallic material since such metallic material can typically have a particularly good thermal conductivity. From the layer arrangement or the reflecting layer heat can therefore enter into the cooling plate and be dissipated or further distributed in this or by this cooling plate. In addition, due to the direct contact of the layer arrangement or the reflecting layer with the cooling plate, a sealing effect can be achieved for the battery cell or the cell case thereof surrounded by the respective layer arrangement with respect to the surroundings of the battery cell or the layer arrangement. By this approach it can optionally be avoided that material escaping from a battery cell undergoing thermal runaway enters between the cooling plate and the cell case of neighbouring battery cells and can thus cause a deterioration of the thermal contact there. This makes it possible to particularly reliably maintain an effective cooling of the remaining battery cells via the cooling plate even when a battery cell undergoes thermal runaway. The layer arrangements or the reflecting layers can be connected to the cooling plate for this purpose, for example, adhesively bonded or welded in order to achieve a particularly good contact.

A further aspect of the present invention is a motor vehicle which has at least one battery device according to an embodiment of the invention. The battery device can in this case in particular be or form a traction battery or a part, for example, a battery module of a traction battery of the motor vehicle. Here the advantages described in connection with the battery device according to an embodiment of the invention can take effect particularly effectively since batteries, in particular traction batteries, of motor vehicles can frequently have a particularly high packing and energy density and a particularly high energy content and as a result of the possible speeds of the motor vehicle compared with stationary applications, an additional potential hazard can exist in the event of the propagation of the thermal runaway of a battery cell through the entire battery or battery device.

Further features of the invention can be obtained from the claims, the figures and the description of the figures. The features and feature combinations mentioned hereinbefore in the description and the features and feature combinations shown hereinafter in the description of the figures and/or in the figures alone can be used not only in the respectively given combination but also in other combinations or alone without departing from the framework of the invention.

Other objects, advantages and novel features of the present invention will become apparent from the following detailed description of one or more preferred embodiments when considered in conjunction with the accompanying drawings.

### BRIEF DESCRIPTION OF THE DRAWING

FIG. 1 shows a schematic of a battery device with two battery cells.

### DETAILED DESCRIPTION OF THE DRAWING

Batteries can contain a plurality of individual cells with the result that, in particular when using the now available and widely used lithium-based cell technologies or cell chemistries, the risk of an exothermic chain reaction triggered by a thermal runaway of an individual cell should fundamentally be taken into account. During the thermal runaway of a cell, temperatures in the range of 400° C. to 1000° C. can be produced at the surface or outside thereof for example. Corresponding thermal energy can reach neighbouring cells via various heat transport mechanisms, with the result that these could also be excited to thermal runaway. A radiative heat transport depends on the emissivity of the respective heat source, here therefore a cell undergoing thermal runaway, and the absorptivity of an exposed material or an exposed surface, here therefore, for example, of a neighbouring cell. In thermal equilibrium the emissivity and the absorptivity are the same. Since emissivities and absorptivities of individual cases typically used nowadays for individual cells are close to 1, i.e. can be relatively high, a radiative heat transport or heat transfer between neighbouring cells can reach significant dimensions in the case of a thermal defect of one of the cells.

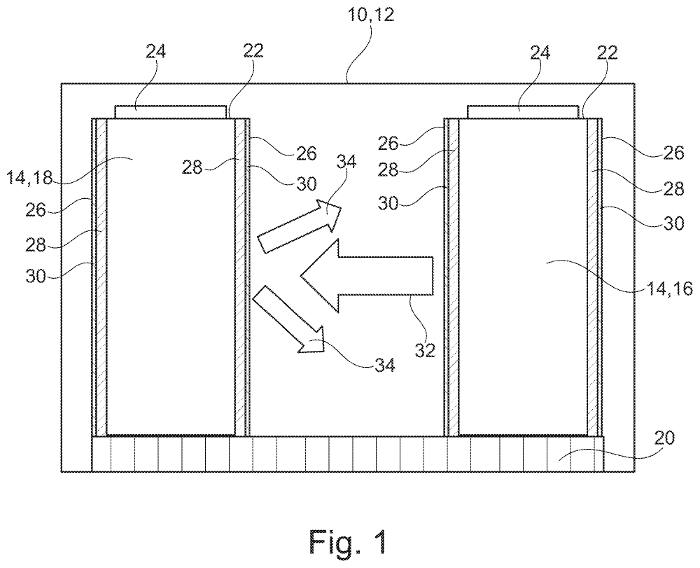

FIG. 1 shows a schematic diagram of a battery device 10 which is robust or resistant to this problem. The battery device 10 can, for example, schematically be or represent a battery module for a traction battery of a motor vehicle or such a traction battery, but is not restricted to these cases of application. The battery device 10 here comprises a battery or outer case 12 in which a plurality of battery cells 14 are accommodated. For the sake of clarity only two battery cells 14 are indicated here, namely a damaged cell 16 and a neighbouring cell 18 arranged adjacent to this in the battery device 10 or the outer case 12. In fact, the battery device 10 can however comprise a plurality of further battery cells 14. The size relationships and distances shown here should be understood purely schematically, i.e. not true to scale.

The battery device 10 in the present case also comprises a cooling plate 20 on which the battery cells 14 are arranged for cooling. The cooling plate 20 can be a metal component which in particular can have one or more channels for a cooling medium. The battery device 10 or the cooling plate 20 can be or are connected, for example, to a cooling circuit of the respective motor vehicle.

The battery cells 14 have individual cell cases 22 which therefore differ from the outer case 12, in which for example a respective electrolyte can be accommodated. The cell cases 22 can, for example, have an at least substantially rectangular or cylindrical shape depending on whether the battery cells 14 comprise prismatic cells or cylindrical cells. Other cell shapes can also be possible.

The battery cells 14 each have a connection point 24 for electrical contacting of the battery cells 14, here for example on their respective upper side. This upper side here lies opposite a respective lower side of the battery cells 14 with which the battery cells 14 stand on the cooling plate 20. Likewise, an arrangement of the connection points 24 at another location, possibly on the lower side or a respective side surface of the battery cells 14 can be possible. This can, for example, be dependent on a cell format and/or module or battery pack design used specifically in the respective case of application.

In each of the battery cells 14 a respective layer arrangement 26 abuts against lateral surfaces of the cell case 22 extending between the upper and lower sides. These layer arrangements 26 are here constructed from a cell-side carrier layer, here designated as heat insulating layer 28, facing the respective cell case 22 and an outside reflecting layer 30. The carrier or heat-insulating layers 28 can, for example, be formed by a polyimide film which is here coated with the respective reflecting layer 30, for example of vapour-deposited aluminium or the like.

In the case of a thermal defect of the damaged cell 16, thermal radiation 32 here indicated schematically can be emitted from this in the direction of the neighbouring cell 18. There the thermal radiation 32 is incident on the outside reflecting layer 30 of the neighbouring cell 18 or the layer arrangement 26 of the neighbouring cell 18. From these reflecting layers 30 the incident thermal radiation 32 is reflected as reflected radiation 34 here also indicated schematically into the surroundings of the neighbouring cell 18 or back to the damaged cell 16. Energy contained in the reflected radiation 34 thus does not contribute to the heating of the neighbouring cell 18. By this approach the risk that the neighbouring cell 18 is also excited to thermal runaway by the heat or energy emanating from the damaged cell 16 can be reduced.

Nevertheless, heat absorbed by the layer arrangement 26 of the neighbouring cell 18 can be removed via the reflecting layer 30 into the cooling plate 20. By way of the heat insulating layer 28, any ingress of this or a residual amount of heat into the cell case 22 or an interior of the neighbouring cell 18 is reduced or delayed in order to further reduce the risk of thermal runaway of the neighbouring cell 18.

In one variant the cooling plate 20 or a further cooling plate can be arranged on another side of the battery cells 14. Even then the other features proposed here would still be helpful. In particular, a radiative barrier to the respective neighbouring battery cell 14 would then be given by this laterally arranged cooling plate itself at least on the side of the cooling plate.

Overall the described examples show how a thermally insulating and heat-reflecting encasing of cells of a multi-cell battery can be achieved in order to limit the risk of propagation of an exothermic chain reaction over several cells inside the battery.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE LIST

10 Battery device
12 Outer case
14 Battery cells
16 Damaged cell
18 Neighbouring cell
20 Cooling plate
22 Cell case
24 Connection points
26 Layer arrangement
28 Heat insulating layer
30 Reflecting layer
32 Thermal radiation
34 Reflected radiation

What is claimed is:

1. A battery device comprising:
a plurality of battery cells having individual cell cases, wherein:
for each of the battery cells, a side of the battery cell faces a side of another one of the battery cells, and
the side of the battery cell includes an individual layer arrangement comprising a cell-side carrier layer and an outside reflecting layer that abuts the side of the other one of the battery cells.

2. The battery device according to claim 1, wherein:
each of the cell cases comprises an upper side and a lower side opposite the upper side, and a completely circumferential lateral surface connecting the upper side and the lower side, and
each of the lateral surfaces is completely covered by the respective layer arrangement.

3. The battery device according to claim 1,
wherein the carrier layer is formed from an electrically insulating material.

4. The battery device according to claim 1,
wherein the carrier layer is configured to be liquid-tight.

5. The battery device according to claim 1,
wherein the carrier layer is formed from a polymer film.

6. The battery device according to claim 5,
wherein the polymer film is formed from a polyimide.

7. The battery device according to claim 1,
wherein the reflecting layer is configured as a metal coating of the carrier layer.

8. The battery device according to claim 1,
wherein the reflecting layer has a smaller layer thickness than the carrier layer.

9. The battery device according to claim 1, wherein:
the battery device further comprises a cooling plate on which the battery cells are arranged, and
the layer arrangements extend as far as the cooling plate.

10. The battery device according to claim 9,
wherein the reflecting layers extend as far as the cooling plate.

11. A motor vehicle comprising a battery device according to claim 1.

12. The motor vehicle according to claim 11,
wherein the battery device is part of a traction battery.
